(19) United States
(12) Patent Application Publication
(10) Pub. No.: US 2016/0048825 A1
(43) Pub. Date: Feb. 18, 2016

(54) SYSTEM AND METHOD FOR A SECURE ELECTRONIC TRANSACTION USING A UNIVERSAL PORTABLE CARD READER DEVICE

(71) Applicant: EZETAP MOBILE SOLUTIONS PRIVATE LIMITED, Bangalore, Karnataka (IN)

(72) Inventors: SANJAY SWAMY, BANGALORE (IN); BHAKTHA RAM KESHAVACHAR, BANGALORE (IN)

(73) Assignee: Ezetap Mobile Solutions Private Limited, Bangalore (IN)

(21) Appl. No.: 14/779,971

(22) PCT Filed: Mar. 27, 2014
(86) PCT No.: PCT/IN2014/000194

§ 371 Date: Sep. 25, 2015

(30) Foreign Application Priority Data
Mar. 28, 2013 (IN) 4035/CHE/2012

(51) Int. Cl. G06Q 20/32; G06Q 20/40; G06Q 20/36

(52) U.S. Cl. CPC G06Q 20/3226; G06Q 20/3221; G06Q 20/3278; G06Q 20/3674; G06Q 20/325; G06Q 20/4012

(57) ABSTRACT

The embodiments herein provide a method and system for secure electronic transaction using a dongle device and a mobile device. The method comprises inserting a payment card in a dongle device. A type of the card is recognized to activate a respective card reader to read a card data which is processed by a microprocessor. The payment amount input by the user is transmitted along with the card data and a transaction related information through the mobile device to a payment server for processing the card data to authenticate the merchant using a mobile application. The mobile application resides on the mobile device or server. After authenticating the user by verifying the user input PIN, the received data and a transaction request is sent to a banking server to perform an electronic transaction.

### CROSS-REFERENCE TO RELATED APPLICATIONS

This application claims the priority and benefit of an Indian Provisional Patent Application with serial number 4035/CHE/2012 filed on Sep. 28, 2012 and post-dated to Mar. 28, 2013 with the title, “SYSTEM AND A METHOD FOR A SECURE ELECTRONIC TRANSACTION USING A UNIVERSAL PORTABLE CARD READER DEVICE”. The contents of the above application are included in its entirety herein at least by reference. This application is a National Phase Application to the PCT application with serial, number PCT/IN2014/000194 filed on Mar. 27, 2014 and the entire content of which is included in its entirety at least by reference herein.

### BACKGROUND

1. Technical Field

The embodiments herein generally relate to a field of electronic transaction and particularly relates to a field of secure electronic transaction. The embodiments herein more particularly relates to a system and method for a secure electronic transaction using a universal portable card reader device.

2. Description of the Related Art

Currently, there are hundreds of payment card readers in the market. All of them are at least as long as the credit card itself. There exist different types of card readers. One type is traditional card reader with single rails,which allow a card to be held against the base of the reader by the user and moved across the read head of the reader. Another type of card reader guides a card by two sets of rails and a backstop. Once the user has inserted the card against the backstop, the card is read as it is removed from the reader.

The conventional payment card readers for electronic payment are bulky. Further the merchant has to produce the printed receipts for the customer, which is very cumbersome for the merchant handling multiple customers. Also the merchant has to keep a record of all the printed receipts, to avoid a dispute in the transactions. It is advantageous for an individual to make a payment to another individual or merchant by swiping or inserting his payment card through a card reader. To read a payment card today, the device should have the minimal dimensions of the width of the card and the depth determined by the position of the chip contacts. So the conventional payment card readers have to be 55 mm wide and 45 mm deep to read the card.

Also, the conventional payment card readers are different for different type of payment cards. For Example: a NFC card reader is required for reading for NFC cards, smart card reader is required for reading smart cards and magnetic stripe card reader is used for reading magnetic stripe cards etc.

In view of the foregoing, there is a need for a universal portable card reader device for reading any type of cards thereby eliminating the need for a multiple card readers for reading different type of cards. There is also a need for a compact universal portable card reader device. Further, there is a need for a system and method for providing a secure electronic transaction in a cost effective manner.

The above mentioned shortcomings, disadvantages and problems are addressed herein and which will be understood by reading and studying the following specification.

### OBJECTIVES OF THE EMBODIMENTS

The primary object of the embodiments herein is to provide a universal portable card reader device for reading any type of cards such as smart cards, NFC cards, magnetic strip cards, etc., for executing a secure electronic transaction.

Another object of the embodiments herein is to provide, a universal portable device or a dongle for a mobile device for a secure electronic transaction.

Yet another object of the embodiments herein is to provide a keypad on the universal portable device for entering a PIN safely on an open platform.

Yet another object of the embodiments herein is to provide a system and method to enable a machine level encryption of a data for an electronic transaction within a universal portable device.

Yet another object of the embodiments herein is to provide a system and method to enable a fast and efficient electronic transaction.

Yet another object of the embodiments herein is to provide a system and method for electronic transaction in which power consumed by the universal portable device is managed efficiently.

Yet another object of the embodiments herein is to provide a universal portable device or a dongle for a mobile device with retractable mechanism for facilitating the dongle to hold and read a standard payment card.

Yet another object of the embodiments herein is to provide a universal portable device or a dongle for a mobile device loaded with a pre-installed mobile application to transmit the card data along with the transaction related information to the payment server of the production server.

Yet another object of the embodiments herein is to provide a universal portable device or a dongle for accessing the user mobile device through the Bluetooth™ network and for accessing an application at the central server through the user mobile device to transmit the card data along with the transaction related information to the payment server of the production server to transmit the card data along with the transaction related information to the payment server of the production, when the mobile device is not loaded with a pre-installed mobile application and the mobile device accesses the central server through an Internet Protocol network.

These and other objects and advantages of the embodiments herein will,become readily apparent from the following detailed description taken in conjunction with the accompanying drawings.

### SUMMARY

The various embodiments herein provide a method for a secure electronic transaction using a dongle device and a mobile device. The method comprises the steps of inserting a payment card in a slot provided in a dongle device, recognizing a type of the payment card by the dongle device, activating a respective card reader within the dongle device, reading a card data of the inserted payment card of an user by the respective card reader, processing the card data in a microprocessor of the dongle device, entering a payment amount in the dongle device by the user, authenticating the user, and wherein the user is authenticated by verifying a PIN entered by the user, transmitting the card data along with a transaction related information to a user mobile device and the card data is transmitted to the user mobile device through a wireless or wired connection means, transmitting the card data along with transaction related information to a payment: server of the production server through a wireless communication network by the user mobile device, processing the card data in the payment server, authenticating the merchant, sending a transaction request to a banking server system to perform an electronic transaction and transmitting the transaction related information to the banking server system through a gateway server.

According to an embodiment herein, the respective card reader is any one of a magnetic stripe reader, a near filed communication (NFC) reader and a smart card reader.

According to an embodiment herein, the wireless or wired connection means is any one of a communication means selected from a group comprising Bluetooth™, Zigbee and any other wired or wireless protocol communication means or communication means over an Internet Protocol network.

According to an embodiment herein, the user mobile device comprises a pre-installed mobile application. The mobile application transmits the card data along with the transaction related information to the payment server of the production server.

According to an embodiment herein, the user mobile device does not comprise a pre-installed mobile application. The dongle device access an application at the central server through the user mobile device to transmit the card data along with the transaction related information to the payment server of the production server. The dongle accesses the user mobile device through the Bluetooth™ network and the mobile device accesses the central server through an Internet Protocol network.

According to an embodiment herein, the method for a secure electronic transaction using a dongle device and a mobile device further comprises a step of sending an electronic receipt to the user through a short message service (SMS) or an e-mail or through an other electronic method.

According to an embodiment herein, the method for secure electronic transaction using a dongle device and a mobile device further comprises a step of recording a transaction status by a counter of a microchip in the dongle device.

According to an embodiment herein, the transaction information includes an amount of the transaction, an unique PIN data of the payment card entered by the user, an additional data related to the transaction, and a signature of a user.

According to an embodiment herein, the unique PIN is data is anyone of a scrambled PIN data or a PIN block or a onetime password (OTP).

According to an embodiment herein, the method for secure electronic transaction using a dongle device and a mobile device further comprises a step of mapping a merchant ID, a terminal ID, a user ID, IMEI number of the user mobile device, a serial number of the dongle device with the dongle device ID for executing a secure electronic transaction.

The various embodiments herein provide a method for a secure is electronic transaction using a dongle device and a mobile device. The method comprises the steps of inserting a payment card in a slot provided in a dongle device, recognizing a type of the payment card by the dongle device, activating a respective card reader within the dongle device, reading a card data of the inserted payment card of a customer by the respective card reader, processing the card data in a microprocessor of the dongle device, entering a payment amount in the dongle device by the customer, authenticating a customer and the customer is authenticated by verifying a PIN entered by the customer, transmitting the card data along with a transaction related information to a payment server of the production server by the dongle device, processing the card data in the payment server, authenticating a merchant, sending a transaction request to a banking server system to perform an electronic transaction and transmitting the transaction related information to the banking server system through a gateway server.

According to an embodiment herein, the respective card reader is any one of a magnetic stripe reader, a near filed communication (NFC) reader and a smart card reader;

According to an embodiment herein, the card data and the transaction related information are transmitted to a central server, and wherein the central server transmits the card data and the transaction related information to the payment server of the production server.

According to an embodiment herein, the card data and the transaction related information are transmitted to the payment server of the production server through a wired communication means selected from group comprising a WLAN or an Internet Protocol or through a GSM module or a CDMA module.

According to an embodiment herein, the method for secure electronic transaction using a don& device and a mobile device further comprises a step of sending an electronic receipt to the user through a short message service (SMS) or an e-mail.

According to an embodiment herein, the method for a secure electronic transaction using a dongle device and a mobile device further comprises a step of recording a transaction status by a counter of a microchip the dongle device.

According to an embodiment herein, the transaction information includes an amount of the transaction, an unique PIN data of the payment card entered by the user, an additional data related to the transaction, and a signature of a user.

According to an embodiment herein, the unique PIN is data is any one of a scrambled PIN data or a PIN block or a onetime password (OTP).

According, to an embodiment herein, the method for secure electronic transaction using a dongle device and a mobile device further comprises a step of mapping a merchant ID, a terminal ID, a user ID, IMEI number of the user mobile device, a serial number of the dongle device with the dongle device ID for executing a secure electronic transaction.

The various embodiments herein provide a system for a secure electronic transaction using a dongle device. The system comprises a dongle device and the dongle device is a universal portable device capable of reading a payment card data, a production server and a wireless communication network for transferring data signals from the dongle to the production server.

According to an embodiment herein, the dongle device comprises a slot for receiving payment card, an audio pin on the outer peripheral surface for connecting the dongle device physically to the user mobile device, an USB port for connecting the dongle device to the user mobile device and a keypad for entering a valid personal identification number (PIN) and a payment details.

According to an embodiment herein, the slot of the dongle device comprises a magnetic stripe reader, a near filed communication (NFC) reader and a smart card reader, and wherein the slot further comprises at-least two guide posts for guiding the payment card to ensure a proper alignment of the payment card inside the slot.

According to an embodiment herein, the dongle device comprises a comparator for performing F2F decoding and post-processing of data to increase the probability of a secure transaction, a microprocessor for processing the card data, a memory unit for storing the card data, a transformation engine for transforming the card data into a standard mathematical transformation, an encryption engine comprising one or more encryption algorithms for encrypting the payment card data into a cipher data, a tokenizer for converting cipher data into a token data, an encoder for encoding the token data, a counter for keeping a track of status of transaction, a micro-switch and a set of batteries for power supply.

According to an embodiment herein, the dongle device further comprises a card sensing circuit for identifying a type of payment card and accordingly a respective reader such as a magnetic strip reader, or a smart card reader, or a NFC reader is activated to read the payment card data.

According to an embodiment herein, the payment card is any of a card selected from the group comprising a magnetic stripe card, a Near Filed Communication (NFC) card and a smart card with an embedded microchip.

According to an embodiment herein, the dongle device is powered by actuating a micro-switch as soon as the payment card is inserted into the slot.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration, and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for a secure electronic transaction using a dongle device, according to an embodiment herein.

FIG. 2A illustrates a front view of a dongle device for enabling a secure electronic transaction, according to an embodiment herein.

FIG. 2B illustrates a rear view of a dongle device for enabling a secure electronic transaction, according to an embodiment herein.

FIG. 2C illustrates a side view of a device for enabling a secure electronic transaction, according to an embodiment herein.

FIG. 2D illustrates another side view of a dongle device for enabling a secure electronic transaction, according to an embodiment herein.

FIG. 3 illustrates a flowchart explaining a method for a secure electronic transaction using a dongle device and a wireless communication network of a mobile device, according to an embodiment herein.

FIG. 4 illustrates a flowchart explaining a method for a secure electronic transaction using a dongle device, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

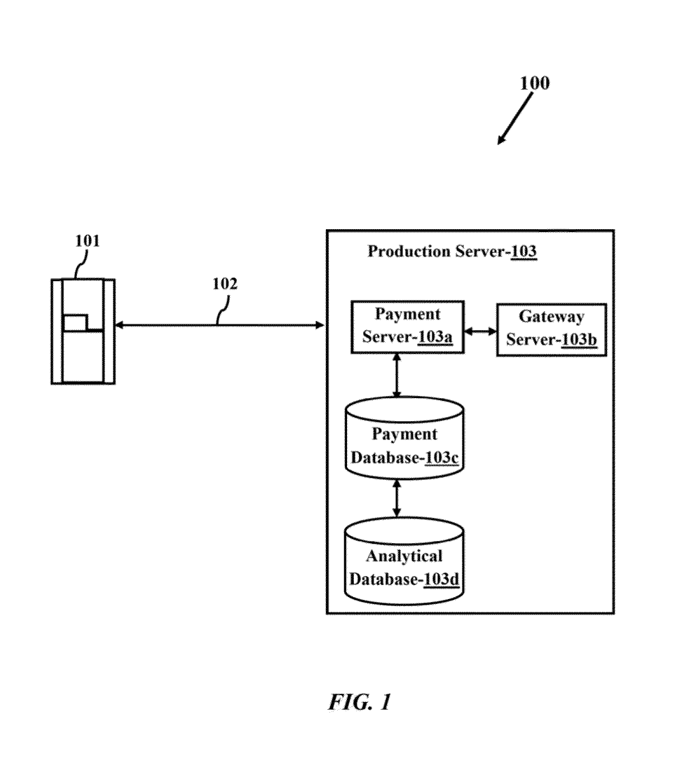

FIG. 1 illustrates a block diagram of a system for a secure electronic transaction using a dongle device, according to an embodiment herein. The system 100 comprises a dongle (universal portable card reader device) 101, a production server 104 and a wireless communication network 102 for transferring data signals from the dongle 101 to the production server 103.

According to an embodiment of the embodiments herein, the production server 103 comprises a payment server 103a for processing a token data, a gateway server 103b for interfacing with plurality of banking systems, a payment database 103c and an analytics database 103d.

According to an embodiment of the embodiments herein, the payment server 103a comprises a decoder for decoding the token data and a decryption engine to convert a cipher text to a normal text. The decryption engine implements one or more decryption algorithms. The cipher is converted using a private key. The private keys are generated randomly by the server.

According to an embodiment of the embodiments herein, the analytics database 103d stores the frequency of transactions for each card.

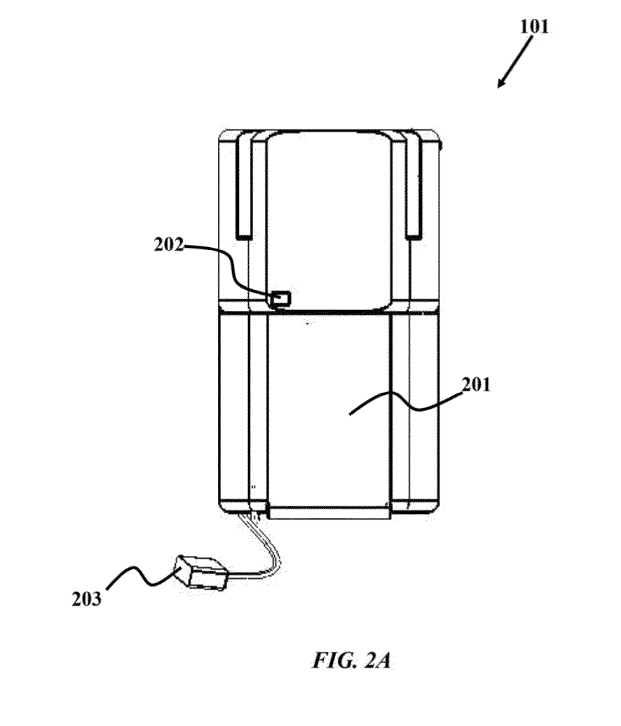

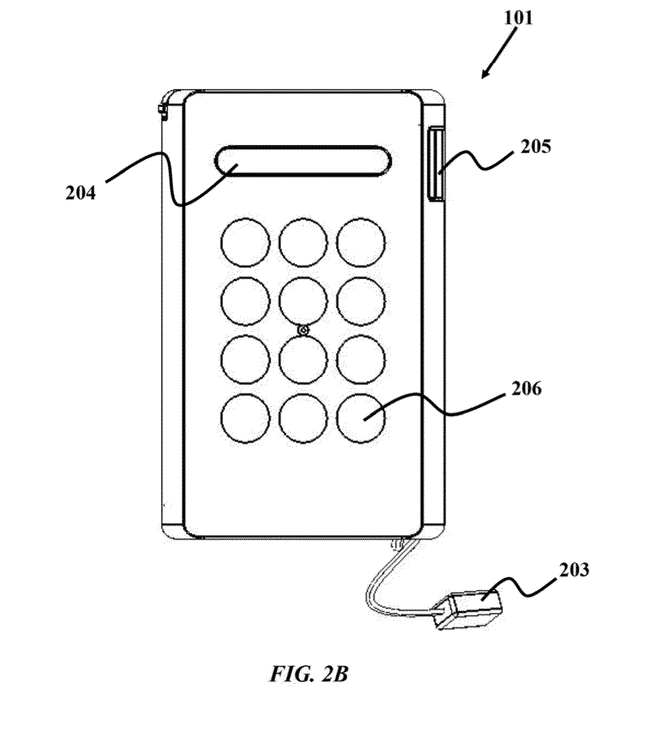

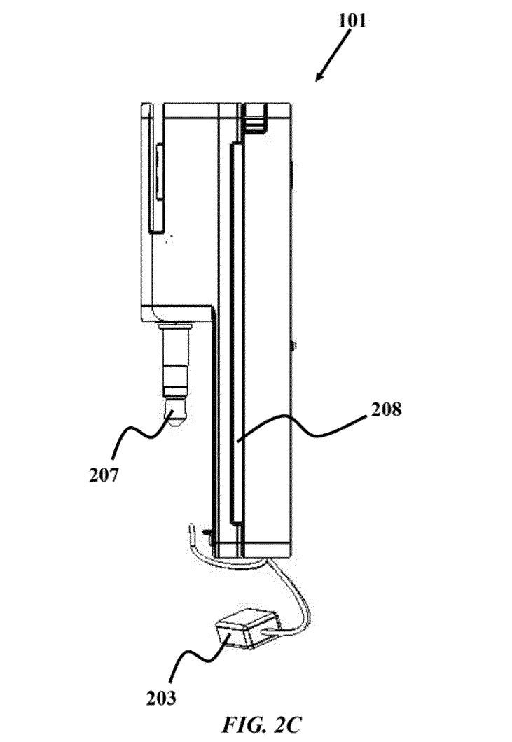

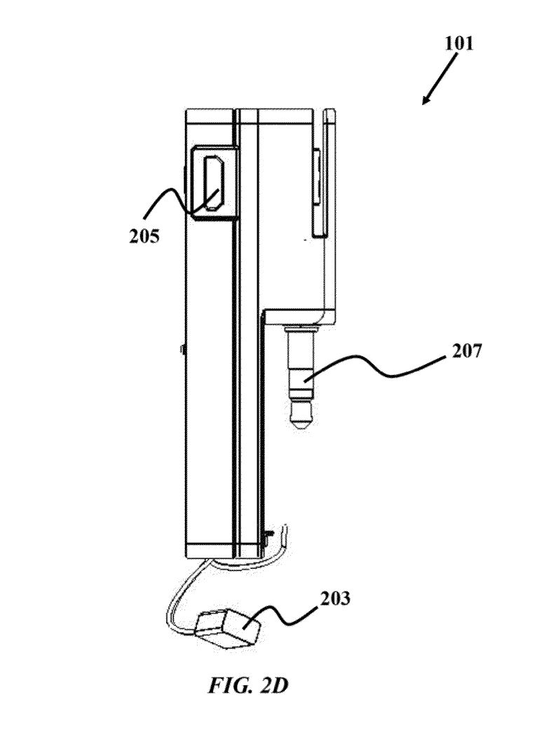

FIG. 2A-FIG. 2D respectively illustrate a front view, a back side view, a left side view and a right side view of a dongle device, according to an embodiment herein. The dongle device 101 comprises a slot 208 for receiving a payment card, an audio pin 207 on the outer peripheral surface for connecting the dongle device 101 physically to the user mobile device, a cover 201 for securing audio pin 207, an USB port 205 for connecting the dongle device 101 to the user mobile device and a keypad 206 for entering a valid personal identification number (PIN) and a payment details, an indicator 202 for indicating ON/OFF of the dongle device 101, a display 204 for displaying the entered/input values and a lanyard 203. The slot 208 of the dongle device 101 comprises a magnetic stripe reader, a near filed communication (NFC) reader and a smart card reader. The slot 208 further comprises at-least two guide posts for guiding the payment card to ensure a proper alignment of the payment card inside the slot 208.

According to an embodiment herein, the dongle device 101 comprises a comparator for performing a F2F decoding and post-processing of data to increase the probability of a secure transaction, a microprocessor for processing the card data, a memory unit for storing the card data, a transformation engine for transforming the card data into a standard mathematical transformation, an encryption engine comprising one or more encryption algorithms for encrypting the payment card data into a cipher data, a tokenizer for converting cipher data into a token data, an encoder for encoding the token data, a counter for keeping a track of status of transaction, a micro-switch and a set of batteries for power supply.

According to an embodiment herein, the dongle device 101 further comprises a card sensing circuit for identifying a type of payment card and accordingly it respective reader such as a magnetic strip reader, or a smart card reader, or a NFC reader is activated to read the payment card data.

According to an embodiment herein, the payment card is any of a card selected from the group comprising a magnetic stripe card, a Near Filed Communication (NFC) card and a smart card with an embedded microchip.

According to an embodiment herein, the dongle device 101 is powered by actuating a micro-switch as soon as the payment card is inserted into the slot 208. The slot 208 further comprises at-least two guide posts. The card is inserted into the slot and is placed between the guide posts to ensure a proper alignment of the card inside the slot. The reading of the card is done without a swipe action. The card's MSR stripe (if present) is read without a swipe. The chip contacts are read (if present) or the NFC is read (if present).

According to an embodiment herein, at-least three guide posts are provided on top of the device to receive a card of any type including a magnetic strip card, contact type smart card, NFC card, etc. the user places the card in the slot formed between the guide posts. The cards are read in a swipe less manner regardless of the type of the card. A card sensing circuit identities the type of card and accordingly a respective reader such as a magnetic strip reader, or a smart card reader, or a NFC reader is activated to read the card.

According to an embodiment of the embodiments herein, the card is a magnetic stripe card or a Near Filed Communication (NFC) card or a smart card. According to an embodiment of the embodiments herein, the card is automatically aligned in the dongle 101 either electronically or mechanically.

According to an embodiment of the embodiments herein, the keypad 206 of the dongle 101 is used for entering a valid personal identification number (PIN). The keypad 206 further comprises a cover for covering, the keypad 206.

According to an embodiment of the embodiments herein, the audio pin 207 provided on the outer peripheral surface of the dongle device 101 is foldable.

According to an embodiment of the embodiments herein, the comparator is used to perform F2F decoding and post-processing of data to increase the probability of a secure transaction.

According to an embodiment of the embodiments herein, the dongle device 101 is powered by a low power amplifier/comparator which uses a first pulse coming out of the MSR head as a result of the card transaction.

According to an embodiment of the embodiments herein, the microprocessor of the dongle device 101 includes an ADC for measuring the voltage level of the battery in the dongle device 101. The measured voltage level is sent along with the transaction data to the production server. The production server collates the battery readings, computes the remaining energy in the battery and sends appropriate information to the end user.

According to an embodiment of the embodiments herein, the encryption engine of the dongle device 101 implements an encryption algorithm. The encryption algorithm is RSA algorithm. The card data is encrypted using a public key.

According to an embodiment of the embodiments herein, the public key of RSA encryption algorithm is buried on the dongle device 101 at the time of manufacturing.

According to an embodiment of the embodiments herein, the is dongle device 101 is powered by actuating a micro-switch as soon as the card is inserted into the slot.

According to an embodiment of the embodiments herein, the set of batteries are rechargeable. The set of batteries are connected in series to provide an adequate power supply for the dongle device 101.

According to an embodiment of the embodiments herein, the payment database comprises the information about the dongle device 101. The information about the dongle device 101 includes a Global Universal Identification (GUID), information related to the dongle device 101 with corresponding GUID such as a serial number of the dongle device 101, a merchant's personal information provided at the time of registration.

According to an embodiment of the embodiments herein, the dongle device 101 is a small and a self powered device with a computing capability. The dongle device 101 transforms the card data using a mathematical transformation. The transformed card data is further encrypted and encoded as a token data. The transformation, encryption and encoding is done in the dongle and thus the card data is never sent to the server. Further, the dongle device 101 sends the token data to a production server through the wireless communication network in the form of an IP data. A server application running in the payment server of the production server decodes and decrypts, performs reverse transformation of the data, authenticates a user and performs the electronic transaction.

According to an embodiment of the embodiments herein, the dongle device 101 comprises a capacitive sensing layer that helps in tamper proofing the dongle device.

According to an embodiment of the embodiments herein, the wireless communication network is any one of a CDMA chip, a wireless transceiver, Bluetooth etc.

According to an embodiment of the embodiments herein, the dongle device 101 comprises reading circuits. The reading circuit recognizes the type of card as soon as the card is inserted into the slot and activates the respective card reader for transaction.

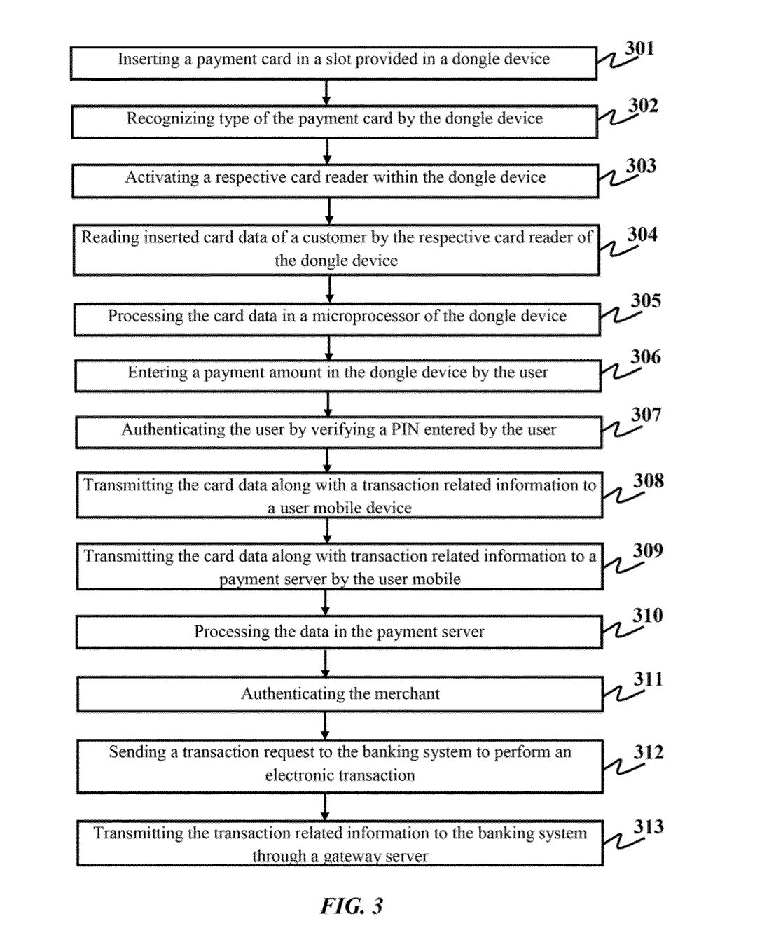

FIG. 3 illustrates a flowchart explaining a method for a secure electronic transaction using a dongle device and a wireless communication network of a mobile device, according to an embodiment herein. The method comprises the steps of inserting a payment card in a slot provided in a dongle device (Step 301), recognizing a type of the payment card by the dongle device (Step 302), activating a respective card reader within the dongle device (Step 303), reading a card data of the inserted payment card of an user by the respective card reader (Step 304), processing the card data in a microprocessor of the dongle device (Step 305), entering a payment amount in the dongle device by the user (Step 306), authenticating the user, and wherein the user is authenticated by verifying a PIN entered by the user (Step 307), transmitting the card data along with a transaction related information to a user mobile device and the card data is transmitted to the user mobile device through a wireless connection means (Step 308), transmitting the card data along with transaction related information to a payment server of the production server through a wireless communication network by the user mobile device (Step 309), processing the card data in the payment server (Step 310), authenticating the merchant (Step 311), sending a transaction request to a banking server system to perform an electronic transaction (Step 312) and transmitting the transaction related information to the banking server system through a gateway server (Step 313).

According to an embodiment herein, the respective card reader is any one of a magnetic stripe reader, a near filed communication (NFC) reader and a smart card reader.

According to an embodiment herein, the wireless connection means is any one of a communication means selected from a group comprising Bluetooth™, or communication means over an Internet Protocol network.

According, to an embodiment herein, the user mobile device comprises a pre-installed mobile application. The mobile application transmits the card data along with the transaction related information to the payment server of the production server.

According to an embodiment herein, the user mobile device does not comprise a pre-installed mobile application. The dongle device access an application at the central server through the user mobile device to transmit the card data along with the transaction related information to the payment server of the production server. The dongle accesses the user mobile device through the Bluetooth™ network and the mobile device accesses the central server through an Internet Protocol network.

According to an embodiment herein, the method for a secure electronic transaction using a dongle device and a mobile device further comprises a step of sending an electronic receipt to the user through a short message service (SMS) or an e-mail.

According to an embodiment herein, the method for secure electronic transaction using a dongle device and a mobile device further comprises a step of recording a transaction status by a counter of a microchip in the dongle device.

According to an embodiment herein, the transaction information comprises an amount of the transaction, unique PIN data of the payment card entered by the user, an additional data related to the transaction, and a signature of a user.

According to an embodiment herein, the unique PIN is data is any one of a scrambled PIN data or a PIN block or a onetime password (OTP).

According to an embodiment herein, the method for secure electronic transaction using a dongle device and a mobile device further comprises a step of mapping a merchant ID, a terminal ID, a user ID, MEI number of the user mobile device, a serial number of the dongle device with the dongle device ID for executing a secure electronic transaction.

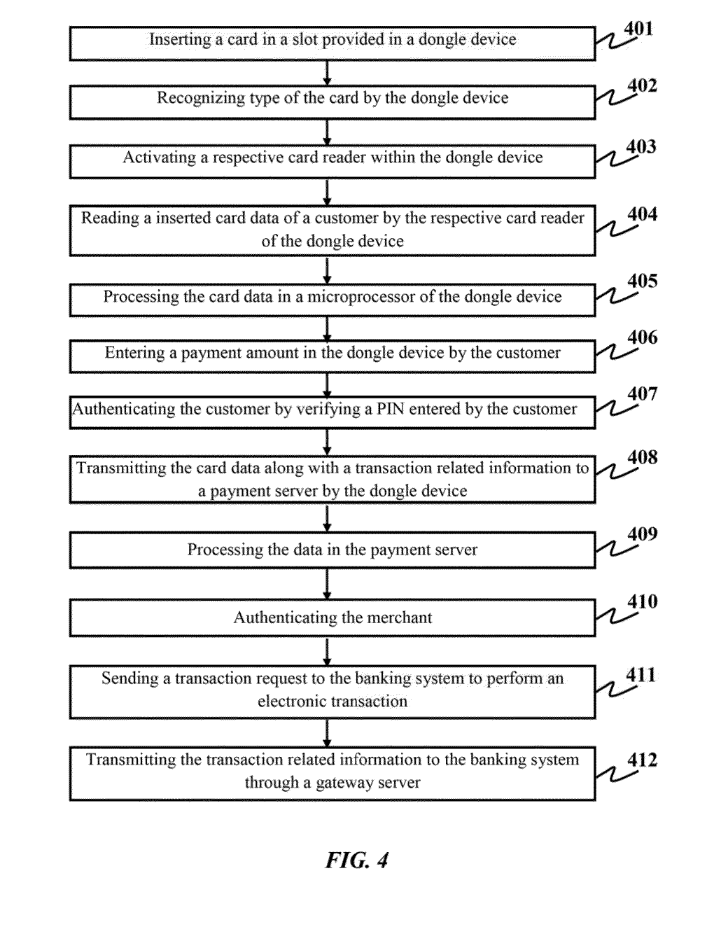

FIG. 4 illustrates a flowchart explaining a method for a secure electronic transaction using a dongle device, according to an embodiment herein. The method comprises the steps of inserting a payment card in a slot provided in a dongle device (Step 401), recognizing a type of the payment card by the dongle device (Step 402), activating a respective card reader within the dongle device (Step 403), reading a card data of the inserted payment card of a customer by the respective card reader (Step 404), processing the card data in a microprocessor of the dongle device (Step 405), entering a payment amount in the dongle device by the customer (Step 406), authenticating a customer and the customer is authenticated by verifying a PIN entered by the customer (Step 407), transmitting the card data along with a transaction related information to a payment server of the production server by the dongle device (Step 408), processing the card data in the payment server (Step 409), authenticating a merchant (Step 410), sending a transaction request to a banking server system to perform an electronic transaction (Step 411) and transmitting the transaction related information to the banking server system through a gateway server (Step 412).

According to an embodiment herein, the respective card reader is any one of a magnetic stripe reader, a near filed communication (NFC) reader and a smart card reader.

According to an embodiment herein, the card data and the transaction related information are transmitted to a central server, and wherein the central server transmits the card data and the transaction related information to the payment server of the production server.

According to an embodiment herein, the card data and the transaction related information are transmitted to the payment server of the production server through a wired communication means selected from a group comprising a WLAN or an Internet Protocol or through a GSM module or a CDMA module.

According to an embodiment herein, the method for secure electronic transaction using a dongle device and a mobile device further comprises a step of sending an electronic receipt to the user through a short message service (SMS) or an e-mail.

According to an embodiment herein, the method for secure electronic transaction using a dongle device and a mobile device further comprises a step of recording a transaction status by a counter of a microchip in the dongle device.

According to an embodiment herein, the transaction information includes an amount of the transaction, unique PIN data of the payment card entered by the user, an additional data related to the transaction, and a signature of a user.

According to an embodiment herein, the unique PIN is data is any one of a scrambled PIN data or a PIN block or a onetime password (OTP).

According to an embodiment herein, the method for secure electronic transaction using a dongle device and a mobile device further comprises a step of mapping a merchant ID, a terminal ID, a user ID, IMEI number of the user mobile device, a serial number of the dongle device with the dongle device ID for executing a secure electronic transaction.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for a secure electronic transaction using a dongle device and a mobile device, the method comprising the steps of:
inserting a payment card in a slot provided in a dongle device;
recognizing a type of the payment card by the dongle device;
activating a respective card reader within the dongle device, and wherein the respective card reader is any one of a magnetic stripe reader, a near filed communication (NFC) reader and a smart card reader;
reading a card data of the inserted payment card of an user by the respective card reader;
processing the card data in a microprocessor of the dongle device;
entering a payment amount in the dongle device by the user;
authenticating the user, and wherein the user is authenticated by verifying a PIN entered by the user;
transmitting the card data along with a transaction related information to a user mobile device, and wherein the card data is transmitted to the user mobile device through a wireless or wired connection means;
transmitting the card data along with transaction related information to a payment server of the production server through a wireless communication network by the user mobile device;
processing the card data in the payment server;
authenticating the merchant;
sending a transaction request to a banking server system to perform an electronic transaction; and
transmitting the transaction related information to the banking server system through a gateway server.

2. The method according to claim 1, wherein the wireless or wired connection means is any one of a communication means selected from a group comprising Bluetooth™, Zigbee and any other wired or wireless protocol communication means over an Internet Protocol network.

3. The method according to claim 1, wherein the user mobile device comprises a pre-installed mobile application, and wherein the mobile application transmits the card data along with the transaction related information to the payment server of the production server.

4. The method according to claim 1, wherein the user mobile device does not comprises a pre-installed mobile application, and wherein the dongle device access an application at the central server through the user mobile device to transmit the card data along with the transaction related information to the payment server of the production server, and wherein the dongle accesses the user mobile device through the Bluetooth™ or any other wired or wireless network and the mobile device accesses the central server through an Internet Protocol network.

5. The method according to claim 1 further comprises sending an electronic receipt to the user through a short message service (SMS) or an e-mail or through any other electronic method.

6. The method according to claim 1, wherein the method further comprises recording a transaction status by a counter of a microchip in the dongle device.

7. The method according to claim 1, wherein the transaction information includes an amount of the transaction, an unique PIN data of the payment card entered by the user, an additional data related to the transaction, and a signature of a user.

8. The method according to claim 1, wherein the unique PIN is data is any one of a scrambled PIN data or a PIN block or a onetime password (OTP).

9. The method according to claim 1 further comprises mapping a merchant ID, a terminal ID, a user ID, IMEI number of the user mobile device, a serial number of the dongle device with the dongle device ID for executing a secure electronic transaction.

10. A method for a secure electronic transaction using a dongle device and a mobile device, the method comprising the steps of:
inserting a payment card in a slot provided in a dongle device;
recognizing a type of the payment card by the dongle device;
activating a respective card reader within the dongle device, and wherein the respective card reader is any one of a magnetic stripe reader, a near filed communication (NFC) reader and a smart card reader;
reading a card data of the inserted payment card of a customer by the respective card reader;
processing the card data in a microprocessor of the dongle device;
entering a payment amount in the dongle device by the customer;
authenticating a customer, and wherein the customer is authenticated by verifying a PIN entered by the customer;
transmitting the card data along with a transaction related information to a payment server of the production server by the dongle device;
processing the card data in the payment server;
authenticating a merchant;
sending a transaction request to a banking server system to perform an electronic transaction; and
transmitting the transaction related information to the banking server system through a gateway server.

11. The method according to claim 10, wherein the card data and the transaction related information are transmitted to a central server, and wherein the central server transmits the card data and the transaction related information to the payment server of the production server.

12. The method according to claim 10, wherein the card data and the transaction related information are transmitted to the payment server of the production server through a wired communication means selected from a group comprising a WLAN or an Internet Protocol or through a GSM module or a CDMA module.

13. The method according to claim 10, wherein the method further comprises sending an electronic receipt to the user through a short message service (SMS) or an e-mail.

14. The method according to claim 10, wherein the method further comprises recording a transaction status by a counter of a microchip in the dongle device.

15. The method according to claim 10, wherein the transaction information includes an amount of the transaction, an unique PIN data of the payment card entered by the user, an additional data related to the transaction, and a signature of a user.

16. The method according to claim 10, wherein the unique PIN is data is any one of a scrambled PIN data or a PIN block or a onetime password (OTP).

17. The method according to claim 10 further comprises mapping a merchant ID, a terminal ID, a user ID, IMEI number of the user mobile device, a serial number of the dongle device with the dongle device ID for executing a secure electronic transaction.

18. A system for a secure electronic transaction using a dongle device, the system comprises:
a dongle device, and wherein the dongle device is a universal portable device capable of reading a payment card data;
a production server; and
a wireless communication network for transferring data signals from the dongle to the production server.

19. The system of claim 18, wherein the dongle device comprises a slot for receiving payment card, an audio pin on the outer peripheral surface for connecting the dongle device physically to the user mobile device, an USB port for connecting the dongle device to the user mobile device and a keypad for entering a valid personal identification number (PIN) and a payment details.

20. The system of claim 18, wherein the slot of the dongle device comprises a magnetic stripe reader, a near filed communication (NFC) reader and a smart card reader, and wherein the slot further comprises at-least two guide posts for guiding the payment card to ensure a proper alignment of the payment card inside the slot.

21. The system of claim 18, wherein the dongle device comprises a comparator for performing F2F decoding and post-processing of data to increase the probability of a secure transaction, a microprocessor for processing the card data, a memory unit for storing the card data, a transformation engine for transforming the card data into a standard mathematical transformation, an encryption engine comprising one or more encryption algorithms for encrypting the payment card data into a cipher data, a tokenizer for converting cipher data into a token data, an encoder for encoding the token data, a counter for keeping a track of status of transaction, a micro-switch and a set of batteries for power supply.

22. The system of claim 18, wherein the dongle device further comprises a card sensing circuit for identifying a type of payment card and accordingly a respective reader such as a magnetic strip reader; or a smart card reader, or a NFC reader is activated to read the payment card data.

23. The system of claim 18, wherein the payment card is any of a card selected from the group comprising a magnetic stripe card, a Near Filed Communication (NFC) card and a smart card with an embedded microchip.

24. The system of claim 18, wherein the dongle device is powered by actuating a micro-switch as soon as the payment card is inserted into the slot.
